(19) United States
(12) Patent Application Publication
(10) Pub. No.: US 2009/0060141 A1
(43) Pub. Date: Mar. 5, 2009

(54) X-RAY APPARATUS

(76) Inventors: Sven Fritzler, Erlangen (DE); Peter Roehrer, Uttenreuth (DE); Peter Schardt, Aisch (DE)

Correspondence Address: SCHIFF HARDIN, LLP;PATENT DEPARTMENT, 6600 SEARS TOWER, CHICAGO, IL, 60606-6473, US

(21) Appl. No.: 12/201,281

(22) Filed: Aug. 29, 2008

(30) Foreign Application Priority Data
Aug. 30, 2007 (DE) 10 2007 041107.5

(51) Int. Cl. H01J 35/06

(52) U.S. Cl. 378/134

(57) ABSTRACT

An x-ray apparatus that has at least one radiator module (1) with a vacuum housing. The at least one radiator module is arranged at least partially around an examination space. The apparatus has an anode segment and, opposite the anode segment, at least two potential-separated cathode segments are arranged in the vacuum housing. The cathode segments thermionically emit electrons upon exposure with laser light. The electrons strike the anode segment and generate x-ray radiation of corresponding energy. Such an x-ray apparatus is more simple structured in terms of design.

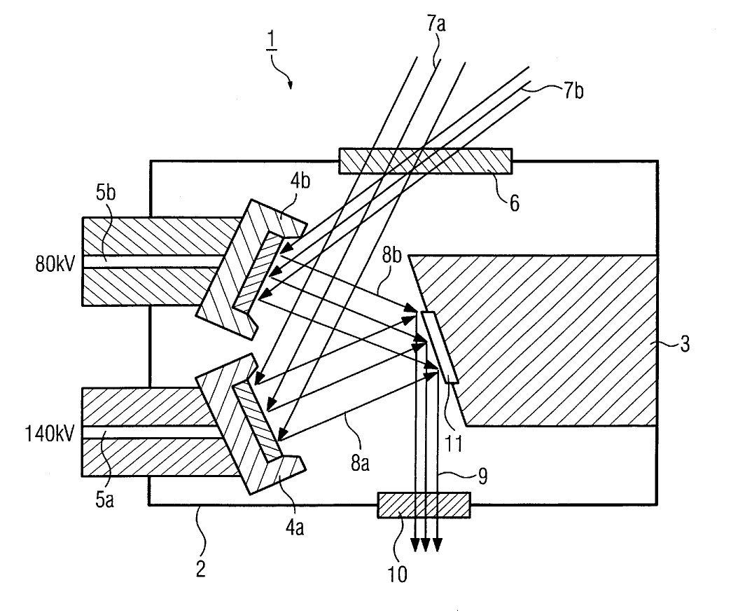

### BACKGROUND OF THE INVENTION

1. Field of the Invention

The invention concerns an x-ray apparatus.

2. Description of the Prior Art

An x-ray apparatus is known from the prospectus “Excellence in CT SOMATOM Definition” from Siemens AG, Order Nr. A91100-M2100-4305-1. Described in this publication is a computed tomography apparatus (CT scanner) that has two x-ray tubes (discrete x-ray radiators) that are each operated with its own high voltage source. Different x-ray energies thus can be generated simultaneously. The two x-ray tubes and the associated x-ray detectors are arranged in a gantry together with a portion of the necessary peripheral apparatuses and aggregates. The gantry is mounted such that it can rotate in a stationary part and surrounds an examination space in the circumferential direction. For an x-ray acquisition of an examination subject (patient) situated in the examination space, both x-ray tubes and the x-ray detectors are moved with the aid of the gantry via electric motor around the patient situated in the examination space.

A CT system with a stationary x-ray tube in which an electron emission controlled by (laser) light on the cathode generates a focal spot on the opposite anode is known from U.S. Pat. No. 4,606,061 as well as the corresponding EP 0 147 009 B1. Focal spots can only be generated with the same x-ray energy due to the arrangement of the cathode and the anode.

Furthermore, an x-ray beam source for an imaging CT system is known from United States Patent Application Publication 2004/0247082 and from the corresponding DE 10 2004 027 092 A1. The x-ray beam source has multiple electron sources that generate electrons of different energy that are accelerated towards a common anode, so x-rays with correspondingly different energies are generated in temporal succession.

Moreover, an x-ray radiator that has a cathode that thermionically emits electrons upon exposure by a laser beam is described in DE 10 2005 043 372 A1.

A computed tomography apparatus that has a stationary x-ray tube that surrounds an examination space in the circumferential direction is also known from EP 0 466 956 A1 as well as the corresponding U.S. Pat. No. 5,125,012. The x-ray tube has an annular anode as well as a cathode ring arranged coaxially to the anode with a number of cathodes that each generate electrons of the same energy. A deflection device is associated with each cathode, each deflection device deflecting the electrons generated in the respective cathode such that one focal path is associated with each cathode. The total number of the foci used for the image reconstruction thereby increases, whereby the image quality is improved.

An angiography apparatus with which 3D images of a patient can be generated in a quasi-tomographic manner is disclosed in DE 10 2005 048 106 A1 and in the corresponding United States Patent Application Publication 2007/0086570 A1, for example. For producing a series of x-ray images, the C-arm that carries an x-ray radiator and a detector system rotates around the patient by approximately 180° with a significant speed.

In all known computed tomography systems, the mechanical design (including the signal and energy transmission to and from the rotating gantry) represents a significant portion of the total cost of the system due to the technical complexity. The same is true for known angiography apparatuses with regard to their C-arm.

### SUMMARY OF THE INVENTION

An object of the present invention is to provide an x-ray apparatus that is constructed more simply in terms of its design.

The x-ray apparatus according to the invention has at least one radiator module with a vacuum housing, wherein the at least one radiator module is arranged at least partially around an examination space, and an anode segment and, opposite the anode segment, at least two potential-separated cathode segments are arranged in the vacuum housing. The cathode segments thermionically emit electrons upon exposure with laser light and the electrons strike the anode segment and generate x-ray radiation of corresponding energy.

In the x-ray apparatus according to the invention, the x-ray tubes for exposure acquisitions need to execute no rotation movements. The high design expenditure that is necessary in known computed tomography systems due to the gantry, with a mass of approximately 1,000 kg, rotating around the examination space is therefore not required in the x-ray apparatus according to the invention. A corresponding cost savings results from the reduced design expenditure. The reduced weight leads to a lower wear and therefore to a greater mechanical stability and to a correspondingly increased lifespan.

In the x-ray apparatus according to the invention, the number of stationary radiator modules can be designed in a simple manner corresponding to the requirement profile. The x-ray apparatus according to the invention is therefore suitable both for medical diagnosis in humans and animals and for the non-destructive examination of different materials (for example luggage).

The x-ray apparatus according to the invention offers further significant advantages in addition to a low-cost mechanism due to the omission of rotating x-ray sources. For example, due to the modular design arbitrary geometries can be realized, in particular for computed tomography and angiography systems. The radiator module can be fashioned, for example, as a curved radiator module, in particular as a radiator module shaped in a circular arc. An embodiment of the invention as a straight radiator module can also be realized in the framework of the invention.

The x-ray apparatus according to the invention can have a single radiator module that is executed as a radiator module rotating 360° in computed tomography systems.

The laser beams generated by the laser source (which weighs approximately 100 kg) can be deflected, for example, onto the cathode segments by mirrors or other optical systems. However, in the framework of the invention it is also possible to arrange the laser source on a gantry and to have it rotate around the longitudinal axis of the x-ray system. Since the gantry must only support approximately 200 kg given two laser sources, such a gantry can be designed with a correspondingly low mass and therefore more simply in terms of design.

In the framework of the invention, the potential-separated cathode segments can lie at the same potential such that, instead of a current load of 1 A given a single cathode segment, a current of only 500 mA respectively flows across two cathode segments in a manner that is advantageous in terms of design, for example.

All cathode segments of the radiator module typically lie at different potentials, wherein a laser source for generation of thermionically emitted electrons of corresponding energy is associated with each cathode segment. Only one detector system is advantageously required for the energetically different x-rays generated by the corresponding electrons in the anode segment.

If the radiator module has two cathode segments, then in medical x-ray apparatuses the one cathode segment advantageously lies at a potential of 140 kV and the other cathode segment lies at a potential of 80 kV. Optimal values for the energy-dependent attenuation and for the tissue-dependent absorption are obtained at these two potentials, whereby an x-ray image with good resolution and good contrast is acquired.

If the electrons thermionically emitted from the two cathode segments strike in a common path radius on the anode segment, particularly simple and therefore correspondingly quick image reconstructions are possible from the data acquired by the detector system. For this purpose the cathode segments are designed in terms of their geometry such that the electrical fields resulting from the geometry and the applied high voltage deflect and/or focus the respective electron beams onto the desired position.

In a further embodiment of the x-ray apparatus according to the invention, the x-ray radiation generated on a common path radius in the anode segment can be collimated by means of a common collimator. This leads again to a weight reduction with the corresponding advantages with regard to design expenditure and lifespan.

### BRIEF DESCRIPTION OF THE DRAWINGS

The FIGURE schematically shows an exemplary embodiment of a radiator module of the x-ray apparatus according to the invention, in a radial section.

### DESCRIPTION OF THE PREFERRED EMBODIMENTS

The subsequently explained exemplary embodiment of an x-ray apparatus according to the invention has a radiator module 1 that is executed as a radiator module revolving 360°. The radiator module 1 possesses a vacuum housing 2 that is arranged in a radiator housing (not shown in the drawing for clarity).

The intervening space between the vacuum housing 2 and the radiator housing is filled with a coolant for high voltage insulation and for heat dissipation.

An anode segment 3 and, opposite this, two potential-separated cathode segments 4a and 4b are arranged in the vacuum housing 2.

The cathode segment 4a lies at a potential of, for example, 140 kV via a high voltage feed-through 5a, in contrast to which the cathode segment 4b lies at a potential of, for example, 80 kV via a high voltage feed-through 5b.

An optical window 6 via which laser light 7a that is emitted by a first laser source enters and strikes the cathode segment 4a is arranged in the vacuum housing 2. Laser light 7b that is emitted by a second laser source and strikes the cathode segment 4b simultaneously enters through the optical window 6. The first and second laser source are likewise not shown for reasons of clarity.

Upon exposure with laser light 7a and 7b, both cathode segments 4a and 4b respectively thermionically emit electrons from which an electron beam 8a and 8b is respectively generated in a known manner. The electron beam 8a is generated from the electrons thermionically emitted by the cathode segment 4a, in contrast to which the electron beam 8b is generated from the electrons thermionically emitted by the cathode segment 4b.

The electron beams 8a and 8b strike the anode segment 3 and generate x-ray radiation 9 of corresponding energy that depends on the potentials applied at the cathode segments 4a and 4b.

The x-ray radiator 9 exits through a radiation exit window 10 arranged opposite the optical window 6 in the vacuum housing 2 and strikes an examination subject (patient; not shown in the drawing), passes through the patient and is then detected in a known manner by a detector system (not shown).

In the exemplary embodiment, the electron beams 8a and 8b thermionically emitted from the two cathode segments 4a and 4b strike in a common path radius 11 on the anode segment 3. The x-ray radiation 9 generated on the common path radius in the anode segment can thereby be collimated by means of a common collimator (not shown in the drawing).

Although modifications and changes may be suggested by those skilled in the art, it is the intention of the inventors to embody within the patent warranted hereon all changes and modifications as reasonably and properly come within the scope of their contribution to the art.

We claim as our invention:

1. An x-ray apparatus comprising:
at least one radiator module having a vacuum housing, said radiator module being disposed at least partially around an examination space;
an anode in said vacuum housing;
at least two potential-separated cathode segments in said vacuum housing opposite said anode segment; and
said cathode segments each emitting electrons upon exposure with laser light, said electrons striking said anode segment and generating x-ray radiation having a radiation energy dependent on the respective potentials of the at least two cathode segments.

2. An x-ray apparatus as claimed in claim 1 wherein said anode segment is at ground potential.

3. An x-ray apparatus as claimed in claim 1 comprising at least two laser sources respectively associated with said at least two cathode segments, and wherein each of said at least two cathode segments is at a different potential.

4. An x-ray apparatus as claimed in claim 3 wherein one of said at least two cathode segments is at a potential of 140 kV and another of said at least two cathode segments is at a potential of 80 kV.

5. An x-ray apparatus as claimed in claim 1 wherein said at least one radiator module proceeds completely around said examination space.

6. An x-ray apparatus as claimed in claim 1 wherein said at least one radiator module has a shape conforming to a circular arc around said examination space.

7. An x-ray apparatus as claimed in claim 1 wherein said at least one x-ray radiator module is curved around at least a portion of said examination space.

8. An x-ray apparatus as claimed in claim 7 wherein said at least one radiator module for use a circular arc.

9. An x-ray apparatus as claimed in claim 1 wherein said anode segment has an arc shape.

10. An x-ray apparatus as claimed in claim 9 wherein each of said at least two cathode segments has an arc shape.

11. An x-ray apparatus as claimed in claim 1 wherein the electrons respectively emitted by said at least two cathode segments all strike said anode on a common path radius.

12. An x-ray apparatus as claimed in claim 11 comprising a collimator that collimates all of the x-ray radiation generated from said common path radius.
